(19) United States
(12) Patent Application Publication
(10) Pub. No.: US 2013/0300690 A1
(43) Pub. Date: Nov. 14, 2013

(54) CONTROL CIRCUIT OF TOUCH SCREEN AND NOISE REMOVING METHOD

(71) Applicants: Jun Hyeok YANG, Daegu-si (KR); Jung Min CHOI, Daejeon-si (KR); Yong Suk KIM, Daegu-si (KR); Hyung Seog OH, Daejeon-si (KR)

(72) Inventors: Jun Hyeok YANG, Daegu-si (KR); Jung Min CHOI, Daejeon-si (KR); Yong Suk KIM, Daegu-si (KR); Hyung Seog OH, Daejeon-si (KR)

(73) Assignee: SILICON WORKS CO., LTD., Daejeon-si (KR)

(21) Appl. No.: 13/869,784

(22) Filed: Apr. 24, 2013

(30) Foreign Application Priority Data
Apr. 25, 2012 (KR) 10-2012-0043165
Apr. 25, 2012 (KR) 10-2012-0043172

(51) Int. Cl. G06F 3/041

(52) U.S. Cl. CPC G06F 3/0416
USPC 345/173

(57) ABSTRACT

The present invention discloses a control circuit of a touch screen and a noise removing method. The present invention provides a technique for performing differential sensing on two adjacent detection lines of a touch screen panel and integrating a differential sensing signal to filter noise. The control circuit and the noise removing method may remove display noise having an effect on two adjacent detection lines, three-wavelength lamp noise having a predetermined frequency, 60 Hz noise, and charger noise caused by battery charging.

### BACKGROUND OF THE INVENTION

1. Field of the Invention

The present invention relates to a touch screen, and more particularly, to a control circuit of a touch screen and a noise removing method, which are capable of removing noise introduced from the touch screen.

2. Description of the Related Art

A touch screen panel (TSP) is configured to detect a user's touch, and divided into a resistive-type TSP, a capacitive-type TSP, and an infrared-type TSP. Recently, a capacitive-type TSP has been frequently used as the TSP. When applied to middle-sized and small-sized mobile product groups, the capacitive-type TSP has superior visibility and durability and exhibits a multi-touch function. In particular, a mutual capacitance-type TSP is mainly used.

A touch screen using a capacitance-type TSP has a low signal-to-noise ratio (SNR) because of various types of noises. The noises having an effect on the touch screen may be divided into random noise and periodic noise. The random noise may include display noise, and the periodic noise may include 60 Hz noise occurring in a fluorescent lamp and 40-50 KHz noise occurring in a three-wavelength inverter lamp. In particular, the periodic noise may include charger noise occurring during battery charging, and the charger noise may be classified as the worst type of noise.

When such noise occurs, a read-out circuit to process a signal of a detection line of a TSP does not accurately recognize charges contained in the sensing line. As a result, an error may occur in touch recognition of the touch screen due to noise.

### SUMMARY OF THE INVENTION

Accordingly, the present invention has been made in an effort to solve the problems occurring in the related art, and an object of the present invention is to provide a control circuit of a touch screen, which differentially senses two adjacent detection lines of a touch screen panel (TSP) and filters noise including display noise.

Another object of the present invention is to provide a control circuit of a touch screen, which differentially senses two adjacent detection lines of a TSP and filters noise including periodic noise using a moving average method.

Another object of the present invention is to provide a control circuit of a touch screen and a noise removing method, which periodically stores a voltage of a detection line outputted from a TSP, integrates and outputs a voltage at a previous period when no noise is detected, and blocks integration of the voltage at the previous period when noise is detected, thereby filtering noise including charger noise.

In order to achieve the above object, according to one aspect of the present invention, there is provided a control circuit of a touch screen, including: a differential sensing unit configured to generate a delta value corresponding to a difference between charges stored in two adjacent detection lines of a touch screen panel; and an integration unit configured to integrate the delta value outputted from the differential sensing unit.

According to one aspect of the present invention, there is provided a noise removing method for a touch screen, including: generating a differential sensing signal corresponding to a difference between detection signals of two adjacent detection lines of a touch screen panel at a predetermined period; storing the differential sensing signal at each period; determining whether or not noise is applied to the two detection lines at each period; and integrating the differential sensing signal stored at a previous period in response to a state in which the noise is not applied, and blocking transmission of the differential sensing signal stored at the previous period for integration in response to a state in which the noise is applied.

According to one aspect of the present invention, there is provided a control circuit of a touch screen, including: a differential sensing unit configured to generate a differential sensing signal corresponding to a difference between detection signals of two adjacent detection lines of a touch screen panel; a noise detection unit configured to generate a noise detection signal which is activated when noise is applied to at least one of the two detection lines; a delay unit configured to store the differential sensing signal at each period and selectively output a differential sensing signal stored at a previous period in response to the noise detection signal; and an integration unit configured to integrate the differential sensing signal transmitted from the delay unit.

### BRIEF DESCRIPTION OF THE DRAWINGS

The above objects, and other features and advantages of the present invention will become more apparent after a reading of the following detailed description taken in conjunction with the drawings, in which:

FIG. 1 illustrates a control circuit of a touch screen according to an embodiment of the present invention;

FIG. 2 is a diagram for explaining the concept of the embodiment illustrated in FIG. 1;

FIG. 3 illustrates a control circuit of a touch screen according to another embodiment of the present invention;

FIGS. 4A to 4D are waveform diagrams for respective nodes of FIG. 3;

FIGS. 5A and 5B illustrate an embodiment in which a path exchanger is added to the embodiment illustrated in FIG. 3;

FIG. 6 is a circuit diagram for simulating response characteristics to various noises introduced to the touch screen according to the embodiment of the present invention;

FIG. 7 illustrates a computer simulation result of the circuit illustrated in FIG. 6;

FIG. 8 illustrates response characteristics of the control circuit of the touch screen according to the embodiment of the present invention;

FIG. 9 illustrates response characteristics of detection lines before differential sensing according to the embodiment of the present invention;

FIG. 10 illustrates response characteristics of the detection lines after integration according to the embodiment of the present invention;

FIG. 11 is a flow chart for explaining a noise removing method for a touch screen according to an embodiment of the present invention;

FIG. 12 is a block diagram illustrating a control circuit of a touch screen according to another embodiment of the present invention;

FIG. 13 is a detailed circuit diagram of the touch screen control circuit of FIG. 12;

FIG. 14 illustrates one example of a comparator 231 of FIG. 13;

FIG. 15 illustrates another example of a comparator 231 of FIG. 13;

FIG. 16 illustrates a comparison circuit 501 of FIG. 15;

FIG. 17 illustrates a comparison circuit 502 of FIG. 15;

FIG. 18 illustrates the relationship comparison voltages which are set according to two detection signals, the highest voltage, and the lowest voltage; and

FIG. 19 is a graph obtained according to the simulation result of FIG. 12.

### DETAILED DESCRIPTION OF PREFERRED EMBODIMENTS

Reference will now be made in greater detail to a preferred embodiment of the invention, an example of which is illustrated in the accompanying drawings. Wherever possible, the same reference numerals will be used throughout the drawings and the description to refer to the same or like parts.

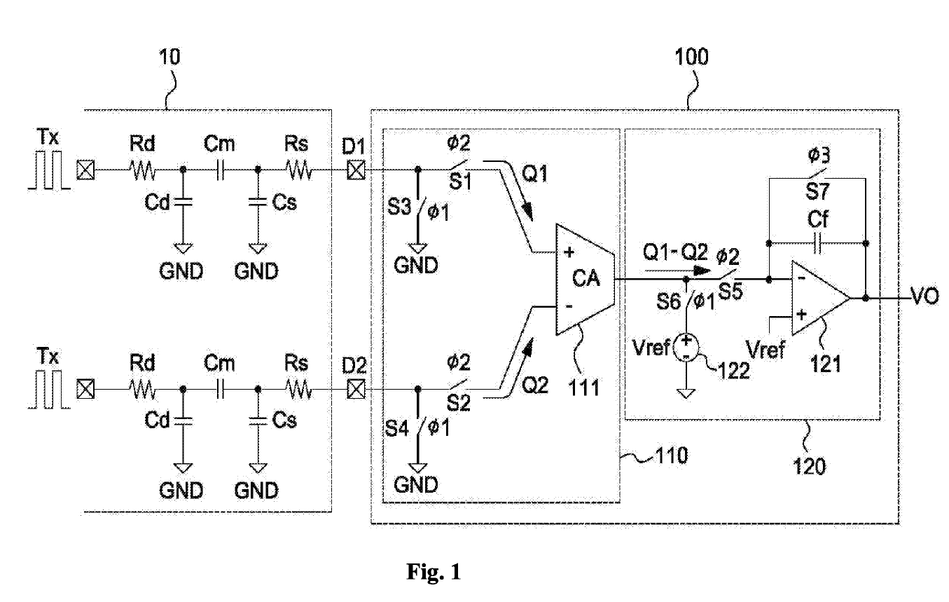

FIG. 1 illustrates a control circuit of a touch screen according to an embodiment of the present invention.

In FIG. 1, a touch screen panel (TSP) 10 and a control circuit 100 of a touch screen are configured.

The TSP 10 includes a plurality of driving lines configured to receive driving voltages Tx and a plurality of detection lines D1 and D2 crossing the driving lines with an insulator interposed therebetween. The control circuit 100 of the touch screen receives detection signals of two adjacent detection lines D1 and D2 and detects whether the touch screen panel 10 is touched or not. The control circuit 100 includes a differential sensing unit 110 and an integration unit 120.

The differential sensing unit 110 is configured to generate a delta value corresponding to a difference between charges Q1 and Q2 stored in the two adjacent detection lines D1 and D2 of the TSP 10, and the integration unit 120 is configured to integrate the output (delta value) of the differential sensing unit 110. Hereafter, the charges Q1 and Q2 stored in the detection lines D1 and D2 mean detection signals of the detection lines D1 and D2.

The differential sensing unit 110 includes a delta value generator 111 and a plurality of switches S1 to S4.

The switches S1 and S3 construct a transmission circuit to transmit the detection signal of the detection line D1 to the delta value generator 111, and the switches S2 and S4 construct a transmission circuit to transmit the detection signal of the detection line D2 to the delta value generator 111.

The switch S1 is connected between the detection line D1 and a positive input terminal (+) of the delta generator 111, and configured to switch transmission of the charge Q1 stored in the detection line D1 to the positive input terminal (+) of the delta value generator 111 in response to a second read signal Φ2. The switch S2 is connected between the detection line D2 and a negative input terminal (−) of the delta generator 111, and configured to switch transmission of the charge Q2 stored in the detection line D2 to the negative input terminal (−) of the delta value generator 111 in response to the second read signal Φ2. The switch S3 is connected to a node between the detection line D1 and the switch S1, and configured to switch transmission of a ground voltage GND to the positive input terminal (+) of the delta value generator 111 in response to a first read signal 401. The switch S4 is connected to a node of between the detection line D2 and the switch S2, and configured to switch transmission of the ground voltage to the negative input terminal (−) of the delta value generator 111 in response to the first read signal Φ1. The second read signal Φ2 may be defined as a signal having the same magnitude as the first read signal Φ1 but having an opposite phase to the first read signal Φ1. Furthermore, the first and second read signals Φ1 and Φ2 may be non-overlap two phase signals. Depending on cases, the driving voltage Tx may be used as the first read signal Φ1.

The delta value generator 111 generates a delta value Δ corresponding to a difference (Q1−Q2) between the charges inputted to the positive input terminal (+) and the negative input terminal, and may be configured with a differential sensor.

The integration unit 120 includes a differential amplifier 121, a reference voltage source 122, a feedback capacitor Cf, and a plurality of switches S5 to S7. The switch S5 is connected between an output terminal of the delta value generator 111 and a negative input terminal (−) of the differential amplifier 121, and configured to switch transmission of the delta value outputted from the delta value generator 111 to the negative input terminal (−) of the differential amplifier 121 in response to the second read signal Φ2. The switch S6 is connected to a node S5 between the output terminal of the delta value generator 111 and the switch S5, and configured to switch transmission of a reference voltage Vref of the reference voltage source 122 to the negative input terminal (−) of the differential amplifier 121 in response to the first read signal 11. The reference voltage Vref is applied to a positive input terminal (+) of the differential amplifier 121. The feedback capacitor Cf and the switch S7 are connected in parallel between the negative input terminal (−) and an output terminal of the differential amplifier 121, and the switch S7 electrically connects the negative input terminal (−) and the output terminal of the differential amplifier 121 in response to a reset signal 13.

Since an equivalent circuit of the TSP 10 illustrated in FIG. 1 is generally known, the detailed descriptions thereof are omitted herein. However, capacitors formed of an insulator and existing between the plurality of driving lines receiving the driving voltages Tx and the plurality of detection lines D1 and D2 outputting detection signals, which cross each other at right angles, are represented by Cm. Furthermore, line resistors of the driving lines and line resistors of the detection lines D1 and D2 are represented by Rd and Rs, and parasitic capacitors formed in the driving lines and the detection lines D1 and D2 are represented by Cd and Cs, respectively.

The embodiment illustrated in FIG. 1 generates a delta value Δ (=Q1−Q2) corresponding to a difference between the charges Q1 and Q2 stored in the two detection lines D1 and D2, in order to remove display noise which commonly influences the two adjacent detection lines D1 and D2. The delta value is sensed by the differential sensing unit 110.

In the embodiment of FIG. 1, the display noise which commonly influences the two adjacent detection lines D1 and D2 may be filtered by differential sensing of the differential sensing unit 110.

Furthermore, the integration unit 120 may perform a moving average method of periodically integrating the delta value Δ (=Q1−Q2) outputted from the differential sensing unit 110, that is, a differential sensing signal, thereby filtering periodic noise.

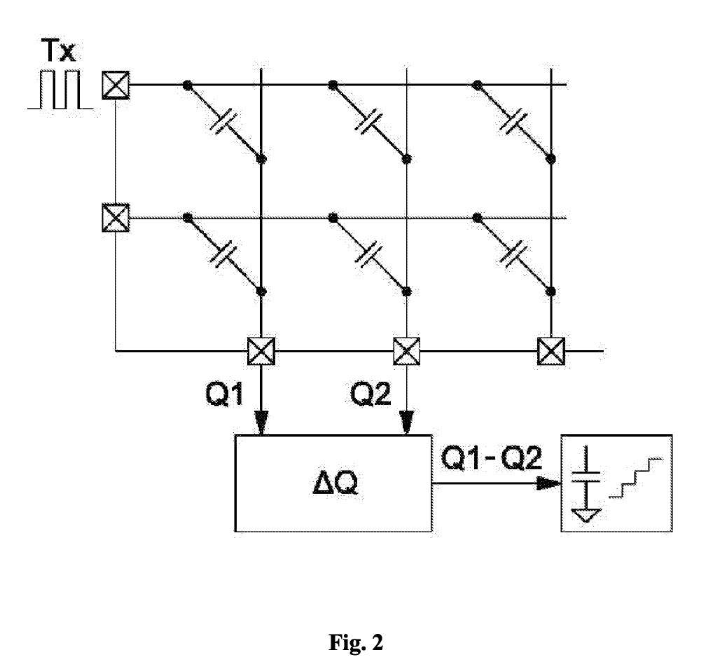

FIG. 2 is a diagram for explaining the concept of the embodiment illustrated in FIG. 1.

FIG. 2 illustrates the concept of the embodiment of FIG. 1, which calculates a delta value corresponding to a difference between two charges Q1 and Q2 stored in two detection lines instead of one detection line, and integrates the delta value.

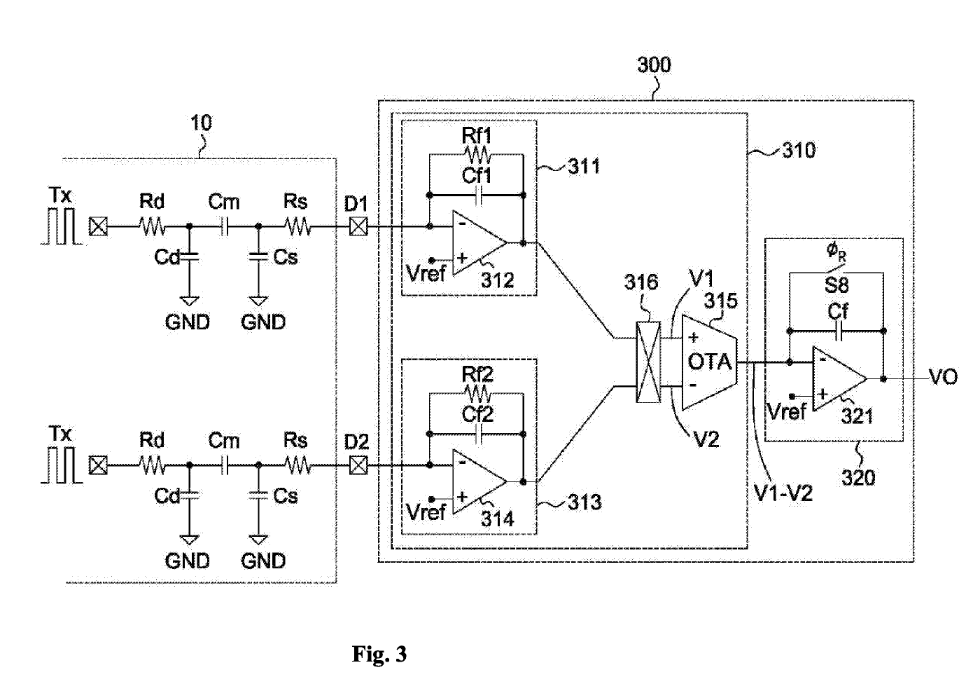

FIG. 3 illustrates a control circuit of a touch screen according to another embodiment of the present invention.

The control circuit 300 of the touch screen of FIG. 3 includes a differential sensing unit 310 and an integration unit 320.

The differential sensing unit 310 includes filters 311 and 313, a differential sensor 315, and a path exchanger 316.

The filter 311 is configured to remove noise introduced from the detection line D1. The filter 313 is configured to remove noise introduced from the detection line D2. The differential sensor 315 is configured to generate a delta value corresponding to a difference (Q1−Q2) between detection signals outputted from the filters 311 and 313, and corresponds to the delta value generator 111 of FIG. 1. The path exchanger 316 is configured to cross outputs of the filters 311 and 312 having a negative value and apply the crossed outputs to two input terminal (+,−) of the differential sensor 315.

The filter 311 includes an amplifier 312. The amplifier 312 has a negative input terminal (−) connected to the detection line D1 and a positive input terminal (+) configured to receive a reference voltage Vref. Between the negative input terminal (−) and an output terminal of the amplifier 312, a feedback resistor Rf1 and a feedback capacitor Cf1 are connected in parallel.

The filter 313 includes an amplifier 314. The amplifier 314 has a negative input terminal (−) connected to the detection line D2 and a positive input terminal (+) configured to receive the reference voltage Vref. Between the negative input terminal (−) and an output terminal of the amplifier 312, a feedback resistor Rf2 and a feedback capacitor Cf2 are connected in parallel.

The differential sensor 315 has a positive input terminal (+) connected to the output terminal of the filter 311 and a negative input terminal (−) connected to the output terminal of the filter 313. The differential sensor 315 may be implemented with an operational transconductance amplifier (OTA) which outputs a delta value to the output terminal.

The path exchanger 316 performs an operation of exchanging input signals such that the output of the integration unit 320 has a one-way property. The signals outputted from the detection lines D1 and D2 in response to a touch on the TSP 10 have a pattern in which a positive value and a negative value are repeated. The path exchanger 316 just transmits a signal having a positive value among input signals from the filters 311 and 312. On the other hand, the path exchanger 316 changes the polarity of a signal having a negative value such that the signal has a positive value, and then transmits the changed signal. Thus, through the above-described operation of the path exchanger 316, the output of the integration unit 320 to integrate the output of the differential sensor 315 may have a one-way property at all times.

The integration unit 320 to integrate the delta value outputted from the differential sensing unit 310 includes a differential amplifier 321. The differential amplifier 321 has a positive input terminal (+) connected to the reference voltage Vref and a negative input terminal (−) configured to receive the delta value, that is, an output of the differential sensor 315. Between the negative input terminal (−) and an output terminal of the differential amplifier 321, a feedback capacitor Cf and a reset switch S8 are connected. The reset switch S8 is configured to switch electric connection between the output terminal and the negative input terminal (−) of the differential amplifier 321 in response to a reset signal Φ_{R}.

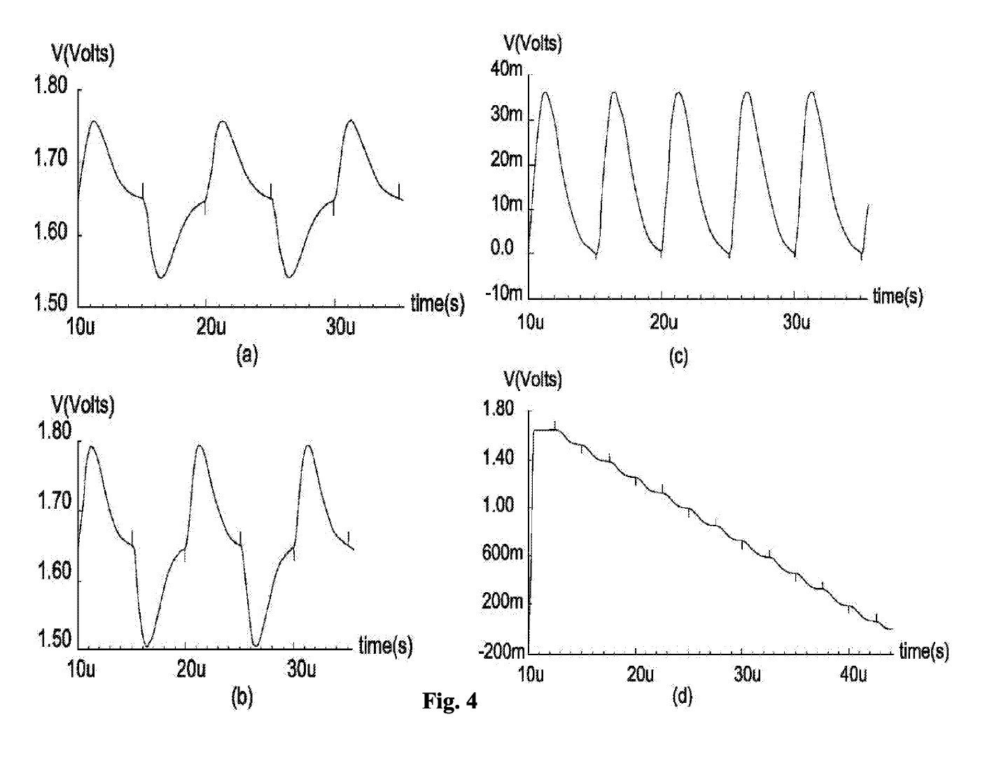

FIGS. 4A to 4D are waveform diagrams for the respective nodes of FIG. 3.

FIG. 4A illustrates an output signal of the filter 311, FIG. 4B illustrates an output signal of the filter 313, FIG. 4C illustrates an output signal of the differential sensor 315, and FIG. 4D illustrates an output signal of the integration unit 320.

The control circuit of FIG. 3 outputs the differential sensing signal as illustrated in FIG. 4C in response to a difference between the signals of FIGS. 4A and 4B which are applied from two detection lines D1 and D2, and the differential sensing signal, that is, the delta value is converted into an integrated signal having a predetermined magnitude as illustrated in FIG. 4D by the integration unit 320.

FIG. 3 illustrates that one path exchanger 316 is installed. However, this configuration is only an example for convenience of description, and the installation may be modified in various manners.

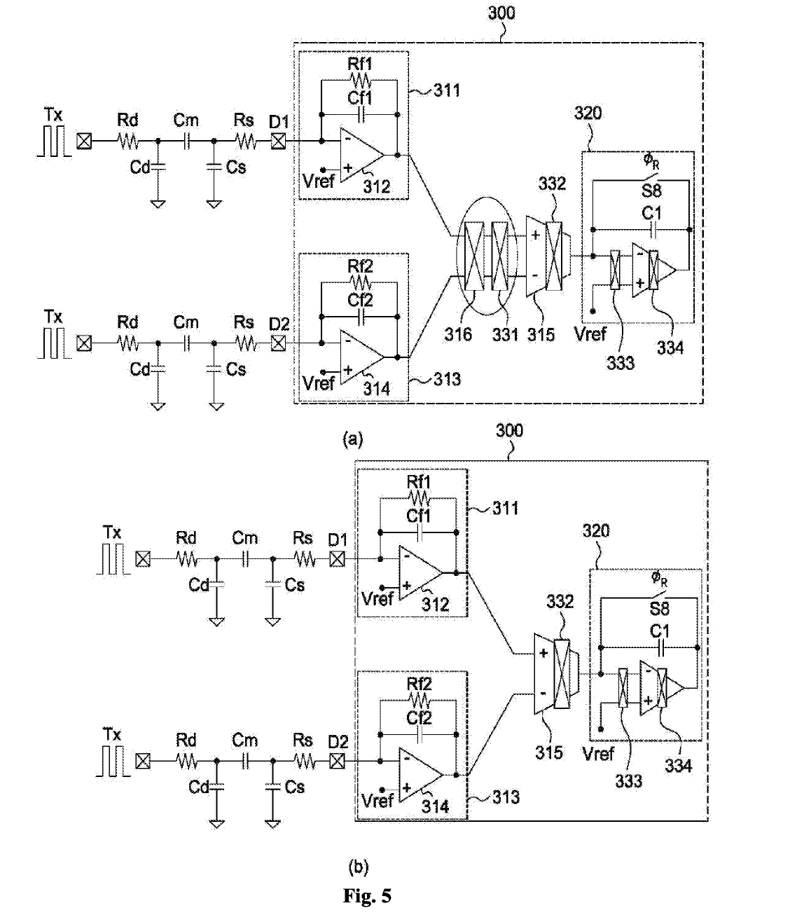

FIGS. 5A and 5B illustrate an embodiment in which a path exchanger is added to the embodiment illustrated in FIG. 3.

Comparing FIG. 5A to FIG. 3, one path exchanger 331 may be added between the differential sensor 315 and the two filters 311 and 313, and another path exchanger 332 may be added to the inside of the differential sensor 315. Furthermore, a path exchanger 333 may be added to two input terminals of the amplifier 321 forming the integration unit 320, and a path exchanger 334 may be added to the inside of the amplifier 321.

In this case, the existing path exchanger 316 and the added path exchanger 334, which are included in an ellipse, offset each other. As a result, two path exchangers 316 and 331 are removed by the offset and only three path exchangers 332, 333, and 334 are installed as illustrated in FIG. 5B.

The control circuit of the touch screen according to the embodiment of the present invention includes an odd number of path exchangers as illustrated in FIG. 3 or 5, thereby effectively acquiring an integrated signal from which periodic noise is filtered.

FIGS. 4A to 4D illustrate response characteristics to touch signals according to the embodiment of the present invention. Hereafter, response characteristics to noise will be described.

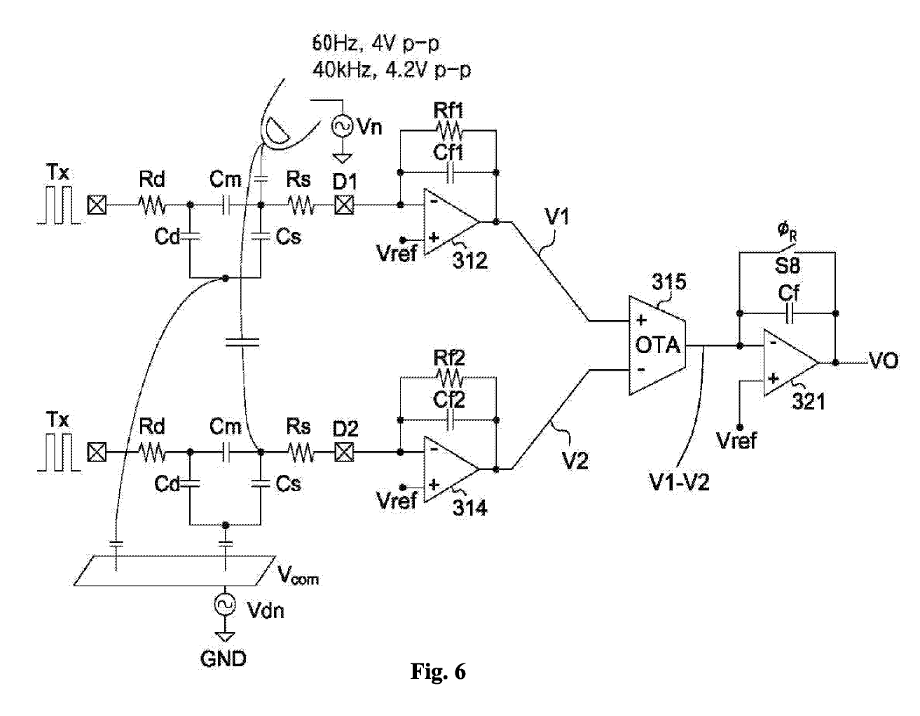

FIG. 6 is a circuit diagram for simulating response characteristics to various noises introduced to the touch screen according to the embodiment of the present invention.

In FIG. 6, suppose that 60 Hz noise applied through a finger when a user touches the touch screen, noise Vn including 40 KHz three-wavelength noise, and display noise Vdn are applied to a TSP to which the embodiment of the present invention is applied. Since the circuit illustrated in FIG. 6 coincides with the circuit illustrated in FIG. 3 and characteristics and introduction paths of the various noises are generally known, the detailed descriptions thereof are omitted herein. In FIG. 6, Vcom represents a common electrode of a display panel (not illustrated). As the common electrode is coupled to the TSP, the display noise Vdn may be introduced to the TSP.

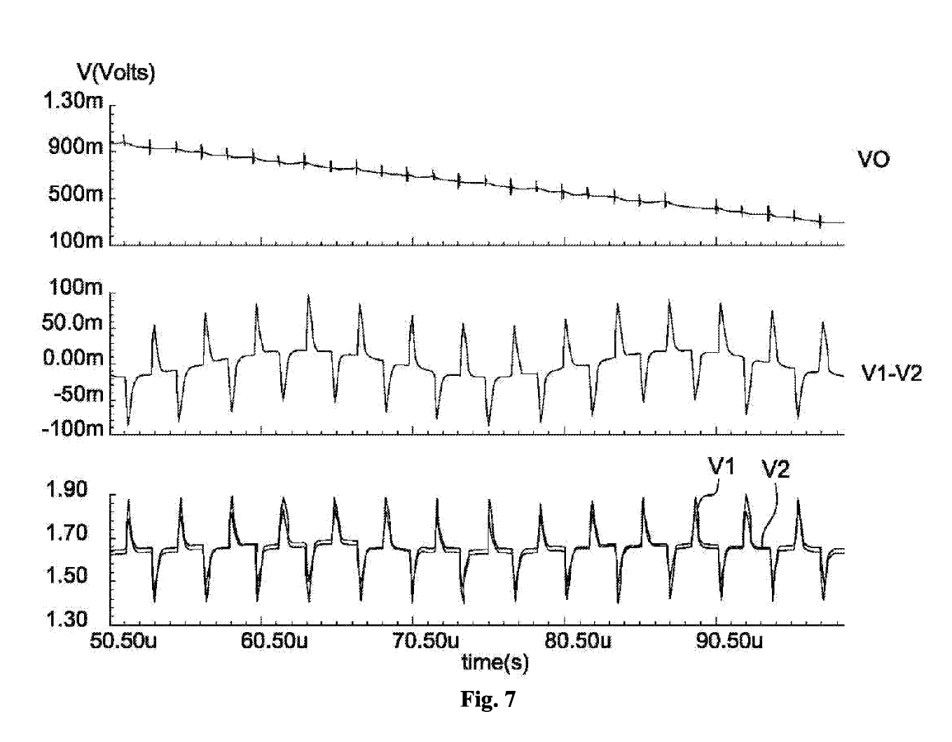

FIG. 7 illustrates a computer simulation result of the circuit illustrated in FIG. 6.

When various noises are introduced as illustrated in FIG. 6, a difference (V2−V1) between an output signal V1 of the filter 311 and an output signal V2 of the filter 313 as illustrated in the lowermost part of FIG. 7 may be known from an output signal of the differential sensor 315, which is illustrated in the middle of FIG. 7. Referring to an output signal Vo of the integration unit 320 which is illustrated in the uppermost part of FIG. 7 and has a constant slope, it can be seen that various noises have almost no effect on the output of the embodiment of the present invention. Although the output signal Vo of the integration unit 320 contains noise, the noise may be ignored.

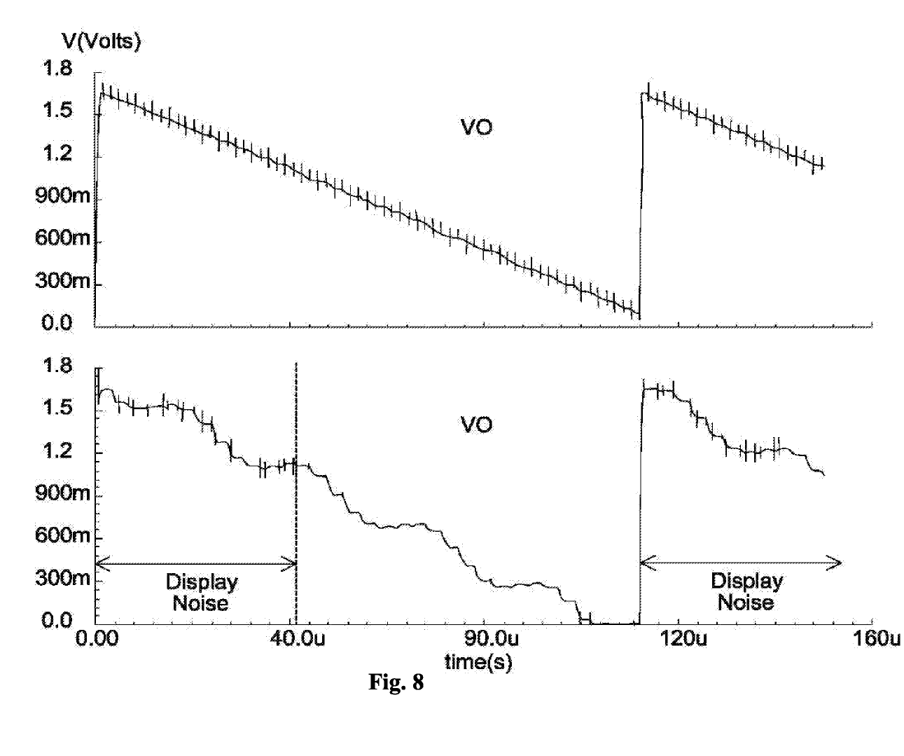

FIG. 8 illustrates response characteristics of the control circuit of the touch screen according to the embodiment of the present invention.

The upper part of FIG. 8 illustrates response characteristics of the control circuit 100 of the touch screen illustrated in FIG. 1, and the lower part of FIG. 8 illustrates response characteristics of the control circuit 100 of the touch screen illustrated in FIG. 3. Referring to FIG. 8, 60 Hz noise of a 4V peak-to-peak voltage and 40 kHz three-wavelength noise of a 10V peak-to-peak voltage were introduced during the entire section, and display noise was introduced only during the initial and final sections.

Referring to FIG. 8, it can be seen that the response characteristic of the control circuit 300 of FIG. 3 in which various noises are considered is more excellent than the response characteristic of the control circuit 100 of FIG. 1 which is focused on display noise.

The control circuit of the touch screen according to the embodiment of the present invention includes the first embodiment of FIG. 1 which integrates a delta value corresponding to a difference between charges of two detection lines and the second embodiment of FIG. 3 which filters charges of two detection lines and integrates a delta value corresponding to a difference between the filtered charges. As known from FIG. 8, the second embodiment has more excellent response characteristics than the first embodiment.

In the second embodiment, however, since the filters are added, an area occupied by the circuit inevitably increases. Thus, the advantages and disadvantages of the first and second embodiments may be considered to apply a required embodiment to a product.

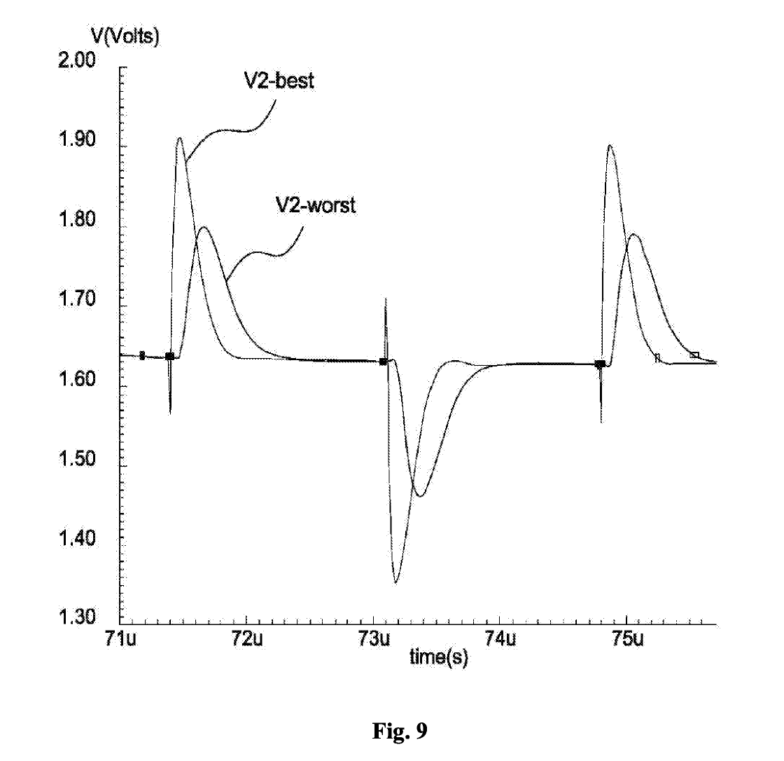

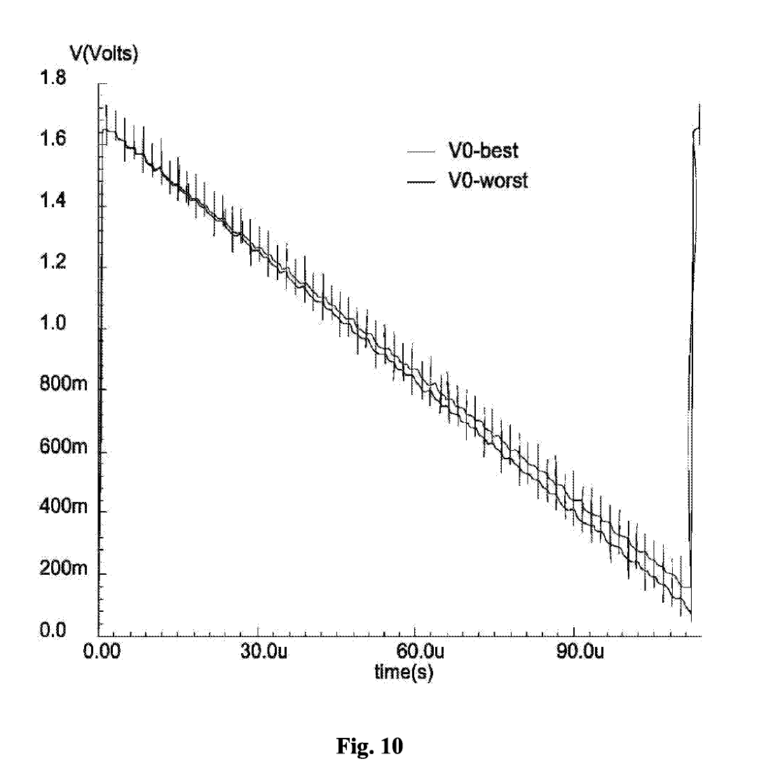

FIG. 9 illustrates response characteristics before differential sensing according to the embodiment of the present invention. FIG. 10 illustrates response characteristics after integration according to the embodiment of the present invention.

Referring to FIG. 9, it can be seen that there is a large difference in response waveform between a case in which a distance between the detection line D2 and the control circuit is the shortest (V2—best) and a case in which the distance between the detection line D2 and the control circuit is the largest (V2—worst), before differential sensing.

Referring to FIG. 10, however, it can be seen that a difference between integrated response waveforms is small even though there is a large difference in response waveform before differential sensing.

In the control circuit of the touch screen according to the embodiment of the present invention, noise introduced when a user touches the touch screen may be removed by two filters of FIG. 3 having a band pass filter characteristic, display noise may be filtered by the differential sensing unit, and a delta value outputted from the differential sensing unit may integrated to thereby improve SNR characteristics.

Referring to FIG. 3, the control circuit of the touch screen according to the embodiment of the present invention performs integration at a falling edge as well as a rising edge of the driving voltage Tx. Thus, the moving average effect may be improved.

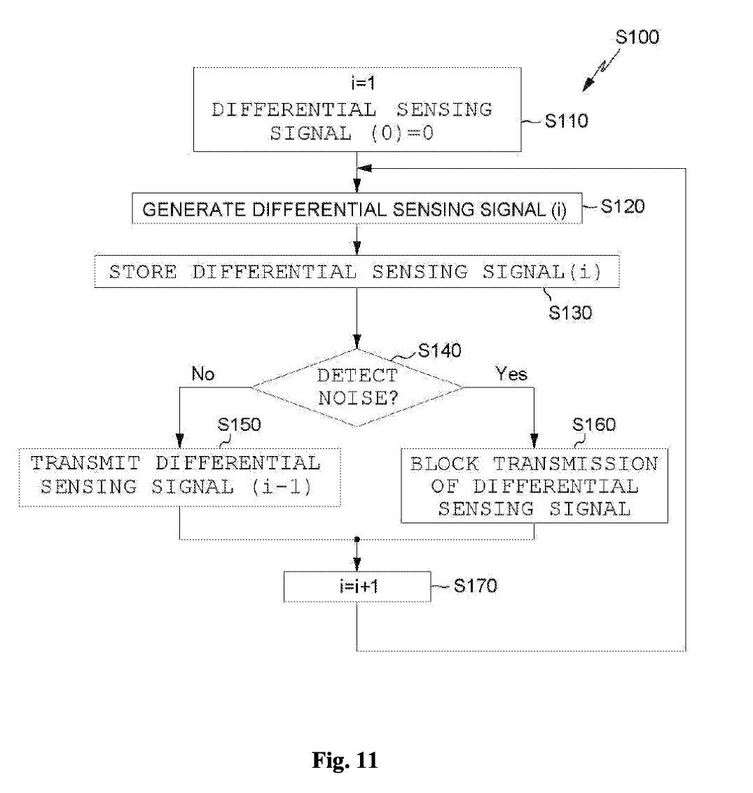

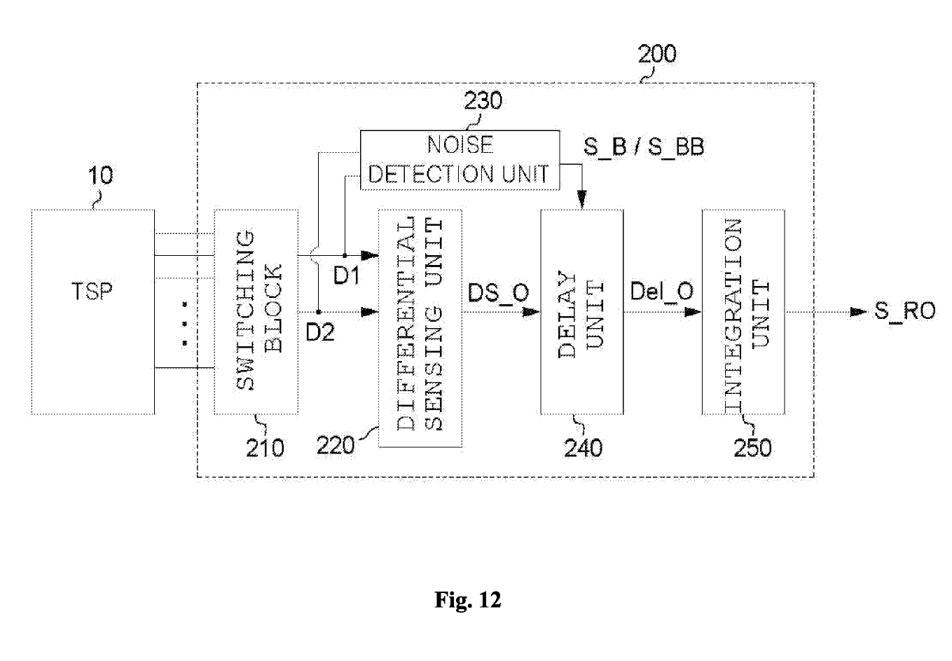

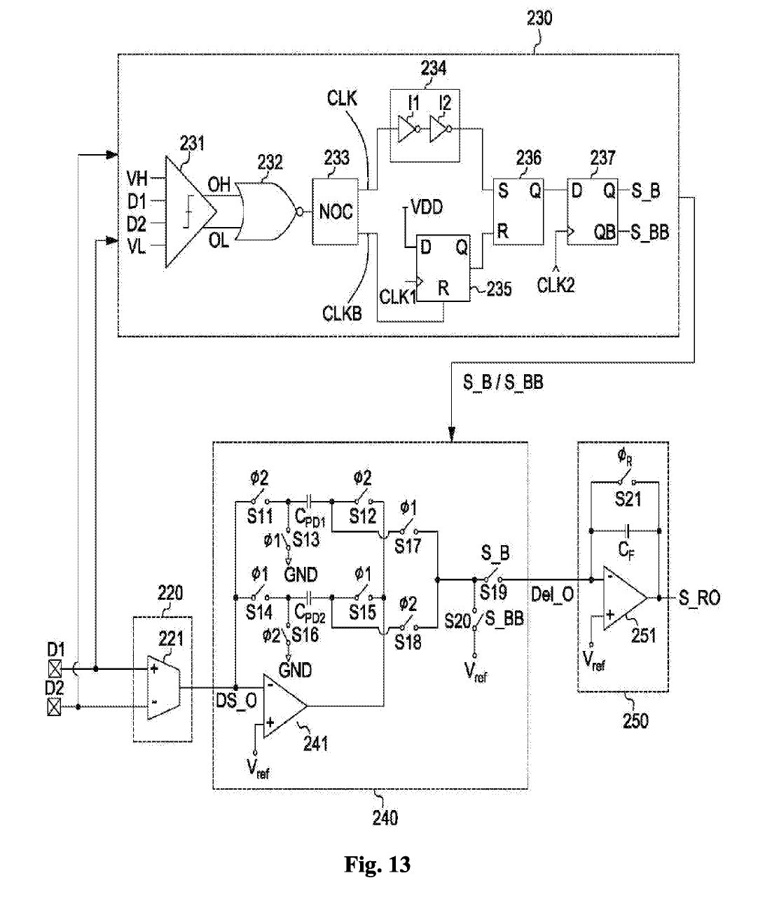

FIG. 11 is a flow chart for explaining a noise removing method for a touch screen according to an embodiment of the present invention. FIG. 12 is a block diagram illustrating a control circuit of a touch screen according to another embodiment of the present invention, which performs the noise removing method of FIG. 11. The control circuit of the touch screen of FIG. 12 may be embodied as illustrated in FIG. 13.

The noise removing method 5100 of FIG. 11 discloses a method for filtering charger noise applied from a TSP, and includes a differential sensing signal generation step S120, a differential sensing signal storage step S130, a noise detection step S140, and signal processing steps S150 and S160.

At the differential sensing signal generation step S120, a differential sensing signal corresponding to a difference between detection signals of two adjacent detection lines D1 and D2 of the TSP is generated at a predetermined period. At the differential sensing signal storage step S130, the differential sensing signal generated at the differential sensing signal generation step S120 is stored at each period. At the noise detection step S140, whether or not noise is applied to the two detection lines D1 and D2 is determined at each period. The signal processing steps S150 and S160 are performed in different manners depending on the noise detection result. When it is determined that no noise is applied, the differential sensing signal stored at the previous period is transmitted for integration at step S150. On the other hand, when it is determined that noise was applied, transmission of the differential sensing signal for integration is not performed but blocked at step S160.

The noise removing method 5100 of FIG. 11 generates the differential sensing signal using the signals applied through the two adjacent detection lines D1 and D2 of the TSP, delays the generated signal by one period, and then transmits the delayed signal. Furthermore, while the transmission of the differential sensing signal is delayed, the noise removing method determines whether or not the detection signals applied from the detection lines D1 and D2 contain noise.

When the detection signals applied from the detection lines D1 and D2 contain no noise, the differential sensing signal inputted and stored at the previous period is transmitted to a subsequent signal processing stage and then integrated, instead of the differential sensing signal which is currently inputted and stored.

When the detection signals applied from the detection lines D1 and D2 contain noise, the differential sensing signal inputted and stored at the previous period is blocked from being transmitted to the subsequent signal processing stage. As a result, the noise may be filtered before the signal processing step.

At an initial value setting step S110 of FIG. 11, a value allocated to a variable i is reset to ‘1’, and differential sensing signals 0 stored before a current step (i=1) are reset to ‘0’. Furthermore, at a variable increase step S170, the variable i is increased by one after the series of processes S120 to s160.

The control method of FIG. 11 may be implemented with a control circuit of FIGS. 12 and 13. FIG. 12 includes a touch screen panel 10 and a control circuit 200.

The control circuit 200 may include a differential sensing unit 220, a noise detection unit 230, a delay unit 240, and an integration unit 250.

The control circuit 250 may include a switch block 210, for example. The switch block 210 may be configured to selectively output charges of two adjacent detection lines D1 and D2 among detection lines of the TSP 10.

The differential sensing unit 220 is configured to sense a difference between detection signals of the two detection lines D1 and D2 and generate a differential sensing signal DS_0. The noise detection unit 230 generates first and second noise detection signals S_B and S_BB which are activated when noise is applied to at least one of the two detection lines D1 and D2. The second noise detection signal S_BB has the same magnitude as the first noise detection signal S_B but has an opposite phase to the first noise detection signal S_B. The delay unit 240 stores the differential sensing signal DS_0 in response to the first and second noise detection signals S_B and S_BB at each period, and transmits a differential sensing signal DS_0 stored at the previous period to the integration unit 250 or blocks the differential sensing signal DS_0 stored at the previous period from being transmitted to the integration unit 250. The integration unit 250 outputs a value S_RO obtained by integrating the differential sensing signal Del_0 transmitted from the delay unit 240.

FIG. 13 is a detailed circuit diagram of the embodiment of FIG. 12.

In FIG. 13, the differential sensing unit 220 generates the differential sensing signals DS_0 through a voltage difference between the two detection lines D1 and D2, and may be implemented with various types of circuits depending on input/output characteristics.

The noise detection unit 230 includes a comparator 231, a NOR gate 232, a clock generator 233, a delay 234, a D flip-flop 235, an SR flip-flop 236, and a D flip-flop 237.

The comparator 231 is configured to generate comparison voltages OH and OL of which the values are set depending on whether or not the detection signals of the two detection lines D1 and D2 fall within a range between the predetermined highest and lowest voltages VH and VL. For this configuration, the comparator 231 may include a multi-input window comparator.

The NOR gate 232 is configured to perform an OR operation on the comparison voltages OH and OL and invert the result of the OR operation.

The clock generator 233 is configured to generate first and second clock signals CLK and CLKB which are two-phase non-overlapping signals, using an signal outputted from the NOR gate 232.

The delay 234 is configured to delay one of the first and second clock signals CLK and CLKB by a predetermined time, and

FIG. 13 illustrates that the delay 234 delays the first clock signal CLK.

The D flip-flop 235 is reset in response to the second clock signal CLKB, and has an input terminal D configured to receive an operating voltage VDD and a clock input terminal configured to receive a third clock signal CLK1.

The SR flip-flop 236 has a set input terminal S configured to receive a signal outputted from the delay 234 and a reset input terminal R configured to receive a signal outputted from an output terminal Q of the D flip-flop 235.

The D flip-flop 237 has an input terminal D configured to receive a signal outputted from an output terminal Q of the SR flip-flop 236, a clock terminal configured to receive a fourth clock signal CLK2, an output terminal Q configured to output the first noise detection signal S_B, and an output terminal QB configured to output the second noise detection signal S_BB.

The third and fourth clock signals CLK1 and CLK2 may have a period two times larger than the integration period, and the phase of the fourth clock signal CLK2 may lead the phase of the third clock signal CLK1 by a predetermined time.

The delay unit 240 may include an amplifier 241, a plurality of delay capacitors C_{PD1} and C_{PD2}, and a plurality of switches S11 to S21.

The amplifier 241 has a negative input terminal (−) configured to receive the differential sensing signal DS_0 and a positive input terminal (+) configured to receive the reference voltage Vref. Between the negative input terminal (−) and an output terminal of the amplifier 241, the delay capacitors C_{PD1} and C_{PD2} are connected in parallel. The switch S11 is connected between the negative input terminal (−) of the amplifier 241 and the delay capacitor C_{PD1}, and configured to switch transmission of the differential sensing signal DS_0 to the delay capacitor C_{PD1} in response to a second read signal Φ₂. The switch 14 is connected between the negative input terminal (−) of the amplifier 241 and the delay capacitor C_{PD2}, and configured to switch transmission of the differential sensing signal DS_0 to the delay capacitor C_{PD2} in response to a first read signal Φ₁. The switch S13 is configured to switch application of a ground voltage to the delay capacitor C_{PD1} in response to the first read signal Φ₁. The switch S16 is configured to switch application of the ground voltage to the delay capacitor C_{PD2} in response to the second read signal Φ₂. The switch S12 is connected between the output terminal of the amplifier 241 and the delay capacitor C_{PD1}, and configured to switch a path for storing the differential sensing signal DS_0 in the delay capacitor C_{PD1} in response to the second read signal Φ₂. The switch S15 is connected between the output terminal of the amplifier 241 and the delay capacitor C_{PD2}, and configured to switch a path for storing the differential sensing signal DS_0 in the delay capacitor C_{PD2} in response to the first read signal Φ₁. The switch S17 is connected to the delay capacitor C_{PD1} in parallel to the switch S12, and configured to switch a path for transmitting the differential sensing signal DS_0 of the delay capacitor C_{PD1} for integration in response to the first read signal Φ₁. The switch S18 is connected to the delay capacitor C_{PD2} in parallel to the switch S15, and configured to switch a path for transmitting the differential sensing signal DS_0 of the delay capacitor C_{PD2} for integration in response to the second read signal Φ₂. The switch S19 is configured to switch connection of a node commonly connected to the switches S17 and S18 to the integrated unit 250 in response to the first noise detection signal S_B. The switch S20 is configured to switch transmission of the reference voltage Vref between a node commonly connected to the switches S17 and S18 and the switch 19 in response to the second noise detection signal S_BB.

The integration unit 250 includes an amplifier 251, a feedback capacitor C_{F}, and a switch S21. The feedback capacitor C_{F} and the switch S21 are connected in parallel between a negative input terminal (−) and an output terminal of the amplifier 251. The amplifier 251 is configured to receive the differential sensing signal Del_0 transmitted from the delay unit 240 through the negative input terminal (−) thereof and receive the reference voltage Vref through a positive input terminal (+) thereof. The switch S21 discharges the feedback capacitor C_{F} in response to a reset signal Φ_{R}.

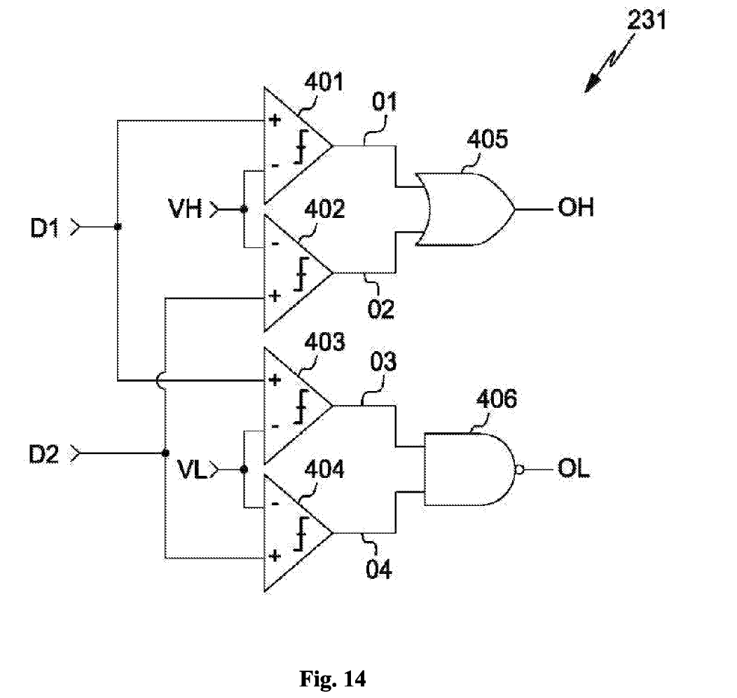

FIG. 14 illustrates an example of the comparator 231 of FIG. 13.

Referring to FIG. 14, the comparator 231 includes comparison circuits 401, 402, 403, and 404, an OR gate 405, and a NAND gate 406.

The comparison circuit 401 is configured to compare a detection signal of the detection line D1 of the two detection lines D1 and D2 to the highest voltage VH and generate an intermediate comparison voltage 01. The comparison circuit 402 is configured to compare a detection signal of the detection line D2 of the two detection lines D1 and D2 to the highest voltage VH and generate an intermediate comparison voltage 02. The comparison circuit 403 is configured to compare the detection signal of the detection line D1 of the two detection lines D1 and D2 to the lowest voltage VL and generate an intermediate comparison voltage 03. The comparison circuit 404 is configured to compare the detection signal of the detection line D2 of the two detection lines D1 and D2 to the lowest voltage VL and generate an intermediate comparison voltage 04. The OR gate 405 is configured to perform an OR operation on the outputs 01 and 02 of the comparison circuits 401 and 402 and generate the comparison voltage OH. The NAND gate 406 is configured to perform an AND operation on the outputs 03 and 04 of the comparison circuits 403 and 404 and invert the AND operation result to generate the comparison voltage OL.

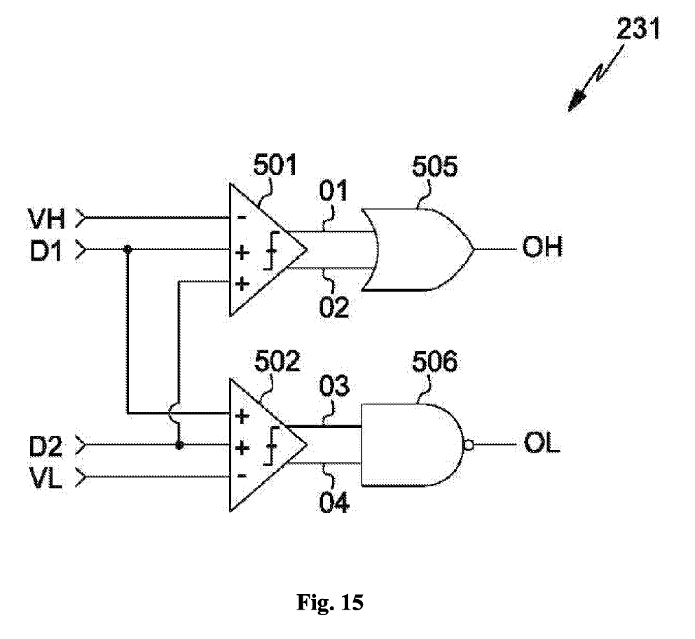

FIG. 15 illustrates another example of the comparator 231 of FIG. 13.

Referring to FIG. 15, the comparator 231 includes comparison circuits 501 and 502, an OR gate 505, and a NAND gate 506.

The comparison circuit 501 is configured to compare detection signals of the two detection lines D1 and D2 to the highest voltage VH and generate the intermediate comparison voltages 01 and 02. The comparison circuit 502 is configured to compare the detection signals of the two detection lines D1 and D2 to the lowest voltage VL and generate the intermediate comparison voltages 03 and 04. The OR gate 505 is configured to perform an OR operation on the intermediate comparison voltages 01 and 02 and generate the comparison voltage OH. The NAND gate 506 is configured to perform an AND operation on the intermediate comparison voltages 03 and 04 and invert the AND operation result to generate the comparison voltage OL.

The comparator illustrated in FIG. 15 is different from the comparator illustrated in FIG. 14 in that the comparator illustrated in FIG. 15 uses two comparison circuits and the comparator illustrated in FIG. 14 uses four comparison circuits. When the comparator using four comparison circuits imposes a burden on the circuit design, a designer may select the comparator using two comparison circuits as illustrated in FIG. 15.

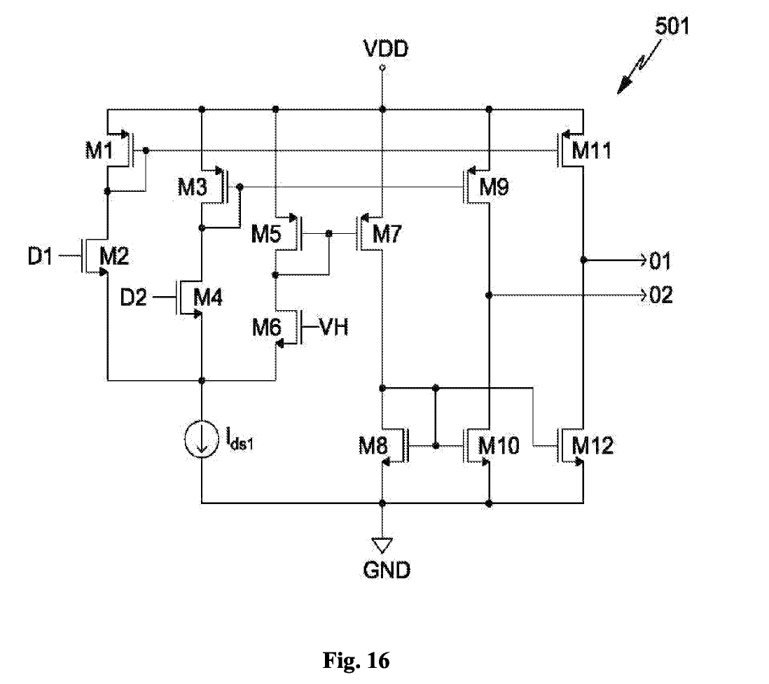

FIG. 16 illustrates the comparison circuit 501 of FIG. 15.

Referring to FIG. 16, the comparison circuit 501 illustrated in FIG. 15 may include one current source I_{ds1} and 12 MOS transistors M1 to M12.

The MOS transistor M1 has one terminal configured to receive an operating voltage VDD and a gate terminal connected to the other terminal thereof. The MOS transistor M2 has one terminal connected to the other terminal of the MOS transistor M1 and a gate terminal configured to receive the detection signal of the detection line D1. The MOS transistor M3 has one terminal configured to receive the operating voltage VDD and a gate terminal connected to the other terminal thereof. The MOS transistor M4 has one terminal connected to the other terminal of the MOS transistor M3 and a gate terminal configured to receive the detection signal of the detection line D2. The MOS transistor M5 has one terminal configured to receive the operating voltage VDD and a gate terminal connected to the other terminal thereof. The MOS transistor M6 has one terminal connected to the other terminal of the MOS transistor M5 and a gate terminal configured to receive the highest voltage VH.

The current source I_{ds1} is commonly connected to the MOS transistors M2, M4, and M6.

The MOS transistor M7 has one terminal configured to receive the operating voltage VDD and a gate terminal connected to the gate terminal of the MOS transistor M5. The MOS transistor M8 has one terminal and a gate terminal connected to the other terminal of the MOS transistor M7 and the other terminal connected to a ground voltage GND. The MOS transistor M9 has one terminal configured to receive the operating voltage VDD and a gate terminal connected to the gate terminal of the MOS transistor M3. The MOS transistor M10 has one terminal connected to the other terminal of the MOS transistor M9, the other terminal connected to the ground voltage GND, and a gate terminal connected to the gate terminal of the MOS transistor M8. The MOS transistor M11 has one terminal configured to receive the operating voltage VDD and a gate terminal connected to the gate terminal of the MOS transistor M1. The MOS transistor M12 has one terminal connected to the other terminal of the MOS transistor M11, the other terminal connected to the ground voltage GND, and a gate terminal connected to the gate terminal of the MOS transistor M8.

The intermediate comparison voltage 01 is outputted to a node connected to the MOS transistors M11 and M12, and the intermediate comparison voltage 02 is outputted to a node connected to the MOS transistors M9 and M10.

In the comparison circuit 501 illustrated in FIG. 16, the MOS transistors M1, M3, M5, M7, M9, and M11 are PMOS transistors, and the other MOS transistors are NMOS transistors.

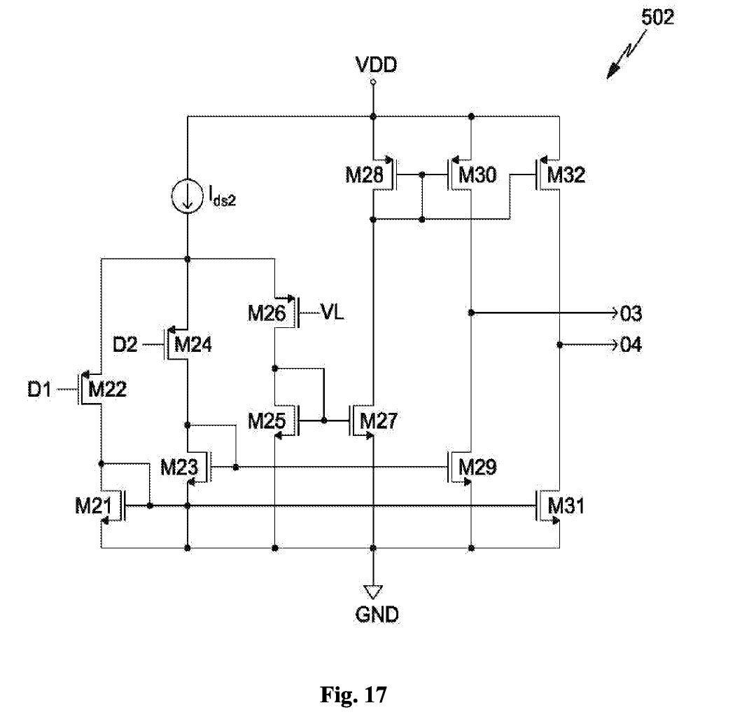

FIG. 17 illustrates the comparison circuit 502 of FIG. 15.

Referring to FIG. 17, the comparison circuit 502 includes one current source I_{ds2} and 12 MOS transistors M21 to M32.

The MOS transistor M21 has one terminal connected to the ground voltage GND and a gate terminal connected to the other terminal thereof. The MOS transistor M22 has one terminal connected to the other terminal of the MOS transistor M21, the other terminal connected to the current source I_{ds2}, and a gate terminal configured to receive the detection signal of the detection line D1. The MOS transistor M23 has one terminal connected to the ground voltage GND and a gate terminal connected to the other terminal thereof. The MOS transistor M24 has one terminal connected to the other terminal of the MOS transistor M23, the other terminal connected to the current source I_{ds2}, and a gate terminal configured to receive the detection signal of the detection line D2. The MOS transistor M25 has one terminal connected to the ground voltage GND and a gate terminal connected to the other terminal thereof. The MOS transistor M26 has one terminal connected to the other terminal of the MOS transistor M25, the other terminal connected to the current source I_{ds2}, and a gate terminal configured to receive the lowest voltage VL.

The MOS transistor M27 has one terminal connected to the ground voltage and a gate terminal connected to the gate terminal of the MOS transistor M25. The MOS transistor M28 has one terminal and a gate terminal connected to the other terminal of the MOS transistor M27 and the other terminal configured to receive the operating voltage VDD. The MOS transistor M29 has one terminal connected to the ground voltage GND and a gate terminal connected to the gate terminal of the MOS transistor M23. The MOS transistor M30 has one terminal connected to the other terminal of the MOS transistor M29, the other terminal configured to receive the operating voltage VDD, and a gate terminal connected to the gate terminal of the MOS transistor M28. The MOS transistor M31 has one terminal connected to the ground voltage GND and a gate terminal connected to the gate terminal of the MOS transistor M21. The MOS transistor M32 has one terminal connected to the other terminal of the MOS transistor M31, the other terminal configured to receive the operating voltage VDD, and a gate terminal connected to the gate terminal of the MOS transistor M28.

The intermediate comparison voltage 03 is outputted to a node connected to the MOS transistors M31 and M32, and the intermediate comparison voltage 04 is outputted to a node connected to the MOS transistors M29 and M30.

In the comparison circuit 502 illustrated in FIG. 17, the MOS transistors M22, M24, M26, M28, M30, and M32 are PMOS transistors, and the other transistors are NMOS transistors.

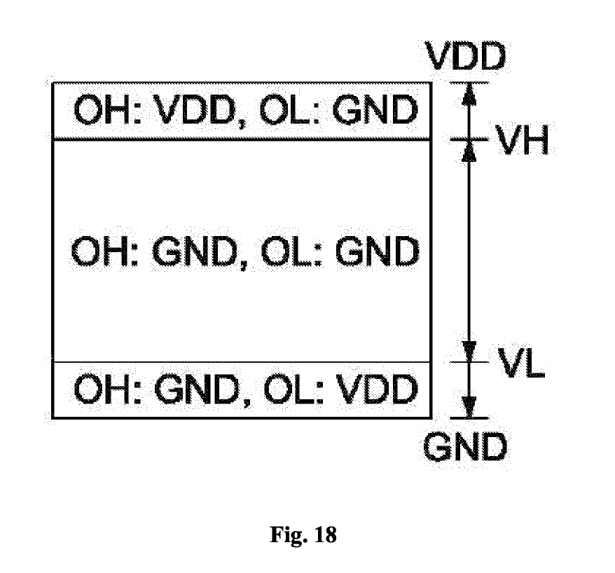

FIG. 18 illustrates the relationship the comparison voltages which are set according to the two detection signals, the highest voltage, and the lowest voltage.

Referring to FIG. 18, when at least one of the detection signals of the two detection lines D1 and D2 is higher than the highest voltage VH or lower than the lowest voltage VL, one of the comparison voltages OH and OL has the level of the operating voltage VDD (logic high level). This case corresponds to a case in which noise is contained, and integration of the differential sensing signal is blocked.

However, when the detection signals of the two detection lines D1 and D2 are lower than the highest voltage VH and higher than the lowest voltage VL at the same time, the comparison voltages OH and OL have the level of the ground voltage GND (logic low level). This case corresponds to a case in which noise is not contained, and the differential sensing signal stored at the previous period is transmitted to the integration unit 250 for integration.

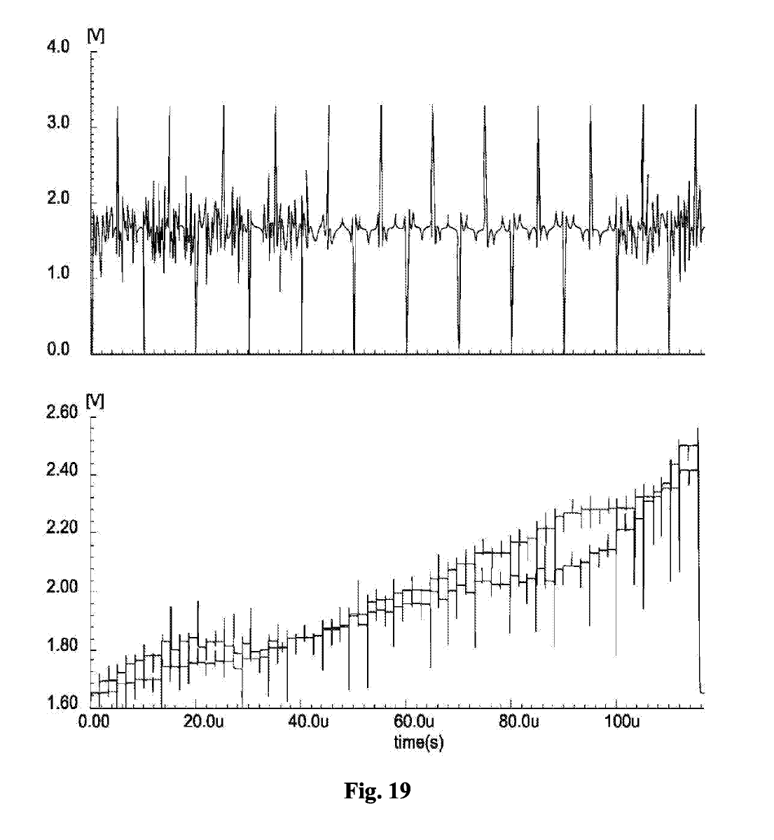

FIG. 19 illustrates output characteristics based on computer simulation results for charger noise according to the embodiment of the present invention.

The upper graph of FIG. 19 illustrates changes of one of the detection signals of the detection lines D1 and D2 in accordance with time, and the lower graph of FIG. 19 illustrates changes of the output voltage of the integration unit 250 in accordance with time. Referring to FIG. 9, it can be seen that when charger noise is applied to the detection lines, an increase tendency (thick solid line) according to the embodiment of the present invention has more excellent linearity than an increase tendency (thin solid line) according to the related art.

Thus, the embodiment of the present invention which has been described with reference to FIGS. 11 to 19 may block large noise such as charger noise from being transmitted to the integration unit 250, thereby obtaining a noise filtering effect.

In the embodiment of FIGS. 11 to 19, the differential voltage is delayed by one period, in order to help understanding. However, the delay period may be set in different manners depending on producers.

According to the embodiments of the present invention, various noises which may have an effect on a touch screen may be previously removed at the analog front end (AFE). Therefore, the burden of a subsequent digital processor may be reduced, and a portion where a touch occurs may be accurately recognized.

Furthermore, as differential sensing is performed on two adjacent detection lines of a TSP, display noise commonly applied to the adjacent detection line may be filtered, and the moving average method may be used to filter periodic noise from the differentially sensed signal.

Furthermore, a charger circuit for integration may be configured with a feedback capacitor having a small capacity, and the adjacent detection lines may be compared to perform noise filtering. Therefore, an additional circuit for compensating for path delay is not required.

Furthermore, a voltage of a detection line outputted from a TSP is periodically stored, and blocking is performed in response to noise detection while the stored voltage is integrated, thereby filtering charger noise.

Although a preferred embodiment of the present invention has been described for illustrative purposes, those skilled in the art will appreciate that various modifications, additions and substitutions are possible, without departing from the scope and the spirit of the invention as disclosed in the accompanying claims.

1. A control circuit of a touch screen, comprising:
a differential sensing unit configured to generate a delta value corresponding to a difference between charges stored in two adjacent detection lines of a touch screen panel; and
an integration unit configured to integrate the delta value outputted from the differential sensing unit.

2. The control circuit of claim 1, wherein the differential sensing unit comprises:
a transmission circuit configured to transmit the charges stored in the two detection lines through periodic switching; and
a delta value generator configured to differentially sense the charges transmitted from the transmission circuit and output the delta value.

3. The control circuit of claim 2, wherein the transmission circuit switches transmission of the charges stored in the two detection lines in response to a driving voltage of the touch screen panel.

4. The control circuit of claim 1, wherein the differential sensing unit comprises:
a first filter configured to band-pass-filter and output any one of detection signals of the two detection lines;
a second filter configured to band-pass-filter and output the other one of the detection signals of the two detection lines; and
a differential sensor configured to output a delta value corresponding to a difference between the detection signals outputted from the first and second filters.

5. The control circuit of claim 4, further comprising a path exchanger between the differential sensor and the first and second filters,
wherein the path exchanger crosses the outputs of the first and second filters in response to the detection signals having a negative value and transmits the crossed outputs to the differential sensor.

6. The control circuit of claim 1, further comprising an odd number of path exchangers in the differential sensor and the integration unit,
wherein each of the path exchangers just transmits an input signal having a positive value among input signals, but changes the polarity of an input signal having a negative value such that the input signal has a positive value, and then transmits the changed signal.

7. The control circuit of claim 1, further comprising an odd number of path exchangers inside the integration unit and before the integration unit,
wherein the integration unit has a one-way output according to signal change of the path exchangers.

8. The control circuit of claim 1, wherein the integration unit repetitively integrates the delta value and filters periodic noise according to a moving average method.

9. The control circuit of claim 7, wherein the integration unit performs the integration in response to rising and falling edges of a driving voltage, in order to perform the moving average method.

10. A noise removing method for a touch screen, comprising:
generating a differential sensing signal corresponding to a difference between detection signals of two adjacent detection lines of a touch screen panel at a predetermined period;
storing the differential sensing signal at each period;
determining whether or not noise is applied to the two detection lines at each period; and
integrating the differential sensing signal stored at a previous period in response to a state in which the noise is not applied, and blocking transmission of the differential sensing signal stored at the previous period for integration in response to a state in which the noise is applied.

11. The noise removing method of claim 10, wherein in the storing of the differential sensing signal,
the differential sensing signal is stored by delay.

12. A control circuit of a touch screen, comprising:
a differential sensing unit configured to generate a differential sensing signal corresponding to a difference between detection signals of two adjacent detection lines of a touch screen panel;
a noise detection unit configured to generate a noise detection signal which is activated when noise is applied to at least one of the two detection lines;
a delay unit configured to store the differential sensing signal at each period and selectively output a differential sensing signal stored at a previous period in response to the noise detection signal; and
an integration unit configured to integrate the differential sensing signal transmitted from the delay unit.

13. The control unit of claim 12, wherein a comparison voltage for detecting charger noise is set in the noise detection unit.

14. The control circuit of claim 12, wherein the noise detection unit comprises a comparator configured with a multi-input window comparator to generate first and second comparison voltages for generating the noise detection signal, and the comparator generates the first and second comparison voltages having a level difference when the detection signals of the two detection lines are higher than the preset highest voltage and lower than the preset lowest voltage, and generates the first and second comparison signals having the same level when the detection signals of the two detection lines have a level between the highest voltage and the lowest voltage.

15. The control circuit of claim 14, wherein the comparator comprises:
a first comparison circuit configured to compare a first detection signal of the detection signals of the two detection lines to the highest voltage;
a second comparison circuit configured to compare a second detection signal of the detection signals of the two detection lines to the lowest voltage;
a NOR gate configured to perform an OR operation on outputs of the first and second comparison circuits and output the first comparison voltage;
a third comparison circuit configured to compare the lowest voltage and the first detection signal;
a fourth comparison circuit configured to compare the lowest voltage and the second detection signal; and
an AND gate configured to perform an AND operation on outputs of the third and fourth comparison circuits and output the second comparison voltage.

16. The control circuit of claim 14, wherein the comparator comprises:
a first comparison circuit configured to receive the highest voltage and first and second detection signals as detection signals of the two detection lines, and output a first intermediate comparison voltage obtained by comparing the highest voltage and the first detection signal and a second intermediate comparison voltage obtained by comparing the highest voltage and the second detection signal;
a NOR gate configured to perform an OR operation on the first and second intermediate comparison voltages and output the first comparison voltage;
a second comparison circuit configured to receive the lowest voltage and the first and second detection signals, and output a third intermediate comparison voltage obtained by comparing the lowest voltage and the first detection signal and a fourth intermediate comparison voltage obtained by comparing the lowest voltage and the second detection signal; and
an AND gate configured to perform an AND operation on the third and fourth intermediate comparison voltages and output the second comparison voltage.

17. The control circuit of claim 12, wherein the delay unit comprises:
two or more delay capacitors configured to store the differential sensing signals having different periods; and
a switch configured to selectively output the differential sensing signal outputted from any one of the two or more delay capacitors in response to the noise detection signal.
